(19) United States
(12) Patent Application Publication
(10) Pub. No.: US 2006/0123147 A1
(43) Pub. Date: Jun. 8, 2006

(54) Information managing apparatus, program search method, and program for implementing the method

(75) Inventor: Hiroshi Yasuhara, Kawasaki-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/283,968

(22) Filed: Nov. 21, 2005

(30) Foreign Application Priority Data
Nov. 22, 2004 (JP) 2004-337762

(51) Int. Cl. G06F 3/00

(52) U.S. Cl. 710/8

(57) ABSTRACT

An information managing apparatus that is capable of reducing the workload placed upon a user searching programs on peripheral devices to obtain necessary information. A user authenticating server is connected to a plurality of peripheral devices via a network. A user authentication is carried out in response to a request from a client terminal, to obtain information related to programs that are installed in each of the plurality of peripheral devices. Information on each of the plurality of peripheral devices and programs is obtained that are stored in each of the plurality of peripheral devices via the network, when authorization is given. It is determined whether search condition designated by the client terminal is a peripheral device or a program. Program information is notified the client terminal in a case where the search condition is a peripheral device, and peripheral device information is notified the client terminal in a case where the search condition is a program.

### BACKGROUND OF THE INVENTION

1. Field of the Invention

The present invention relates to an information managing apparatus, a program search method, and a program for implementing the method. More particularly, the present invention relates to an information managing apparatus that is connected to a plurality of client terminals and to a plurality of peripheral devices via a network, a program search method that is applied to the information managing apparatus, and a program for causing a computer to execute the program search method.

2. Description of the Related Art

Conventionally, a program that is stored in a peripheral device connected to a network, such as a multi-function printing device having image reading, printing and facsimile transmitting/receiving functions, is itself a firmware, and in most cases, the peripheral device stores only a single program. Therefore, as described in Japanese Laid-Open Patent Publication (Kokai) No. 2000-010765 for example, determination of functions of a program that is stored in a peripheral device is carried out by determining the type of the peripheral device.

In recent years, peripheral devices have appeared which have a plurality of programs dynamically installed therein. In these peripheral devices, it is arranged such that information can be obtained on the various programs that are installed in the peripheral devices.

On the other hand, in an environment in which peripheral devices are used, a system that authenticates a user of the peripheral devices, or a network system that imposes restriction on programs which can be used by the user in the peripheral devices according to the authentication, are being constructed.

In such a system that imposes restriction on programs which can be used by the user in the peripheral devices, it is not possible to determine whether usage of the programs is authorized to each user.

For each user to know which programs are available to himself/herself, it is necessary for the users to be authenticated by each peripheral device that is available to the user. This places a heavy workload upon the user searching programs in the peripheral devices. Especially, when each user searches peripheral devices having programs that are available to the user among a plurality of peripheral devices in a network environment, it is necessary to carry out user authentication on each peripheral device and check the type of programs and its availability. Therefore, with the conventional system, a heavy workload is placed upon the user in searching peripheral devices and in searching programs stored in the peripheral devices.

These problems arise because the peripheral devices independently store program managing information respectively, and the program managing information is not shared among the peripheral devices.

### SUMMARY OF THE INVENTION

It is an object of the present invention to provide an information managing apparatus and a program searching method, that are capable of reducing the workload placed upon a user searching programs on peripheral devices to obtain necessary information, and a program for implementing the method.

To attain the above object, in a first aspect of the present invention, there is provided information managing apparatus connected to a plurality of peripheral devices via a network comprising a user authentication executing device that carries out a user authentication in response to a request from a client terminal, to obtain information related to programs that are installed in each of the plurality of peripheral devices, an obtaining device that obtains information on each of the plurality of peripheral devices and programs that are stored in each of the plurality of peripheral devices via the network, when authorization is given by the user authentication executing device, a determining device that determines whether search condition designated by the client terminal is a peripheral device or a program, and a notifying device that notifies the client terminal of program information in a case where the search condition is a peripheral device, and notifies the client terminal of peripheral device information in a case where the search condition is a program.

Preferably, the obtaining device determines whether or not a user of the client terminal requesting the information is authorized to use the programs, and the notifying device notifies the client terminal the programs available to the user.

To attain the above object, in a second aspect of the present invention, there is provided a search program that is applied to an information managing apparatus connected to a plurality of peripheral devices via a network comprising a user authentication executing step of carrying out user authentication in response to a request from a client terminal, to obtain information related to programs that are installed in each of the plurality of peripheral devices, based on user authenticating information stored in a user authenticating information storing device, an obtaining step of obtaining information on each of the plurality of peripheral devices and programs that are stored in each of the plurality of peripheral devices via the network, when authorization is given in the user authentication executing step, a determining step of determining whether search condition designated by the client terminal is a peripheral device or a program, and a notifying step of notifying the client terminal of program information in a case where the search condition is a peripheral device, and notifying the client terminal of peripheral device information in a case where the search condition is a program.

Preferably, the obtaining step determines whether or not a user of the client terminal requesting the information is authorized to use the programs, and the notifying step notifies the client terminal the programs available to the user.

To attain the above object, in a third aspect of the present invention, there is provided a program for causing a computer to execute a search program that is applied to an information managing apparatus connected to a plurality of peripheral devices via a network comprising a user authentication executing step of carrying out user authentication in response to a request from a client terminal to obtain information related to programs that are installed in each of the plurality of peripheral devices, based on user authenticating information stored in a user authenticating information storing device, an obtaining step of obtaining information on each of the plurality of peripheral devices and programs that are stored in each of the plurality of peripheral devices via the network, when authorization is given in the user authentication executing step, a determining step of determining whether search condition designated by the client terminal is a peripheral device or a program, and a notifying step of notifying the client terminal of program information in a case where the search condition is a peripheral device, and notifying the client terminal of peripheral device information in a case where the search condition is a program.

The above and other objects, features, and advantages of the present invention will become more apparent from the following detailed description taken in conjunction with the accompanying drawings.

### BRIEF DESCRIPTION OF THE DRAWINGS

FIG. 1 is a block diagram showing the construction of a peripheral device according to an embodiment of the present invention;

FIG. 2 is a block diagram showing the hardware construction of the peripheral device of FIG. 1;

FIG. 3 is a block diagram showing the hardware construction of a personal computer (PC) according to an embodiment of the present invention that configures a network system together with the peripheral device of FIG. 1;

FIG. 4 is a block diagram showing the configuration of a network system configured by the peripheral devices (NFPs) of FIG. 1 and the PCs of FIG. 3;

FIG. 5 is a block diagram showing the arrangement of functions of a controller of the peripheral device of FIG. 1;

FIG. 6 is a block diagram showing the arrangement of functions of a user authenticating server (PC(1));

FIG. 7A is a diagram showing a user information managing table for user authentication;

FIG. 7B is a diagram showing an application program information managing table;

FIG. 7C is a diagram showing a peripheral device information managing table;

FIG. 7D is a diagram showing a program information managing table;

FIG. 8 is a flowchart showing the procedure of a searching process that is carried out by the user authenticating server (PC(1));

FIG. 9 is a flowchart showing the procedure of an information obtaining and transmitting process that is carried out on peripheral devices (MFP(1) and MFP(2)) according to a peripheral device information obtaining process in a step S403 in FIG. 8; and

FIG. 10 is a flowchart showing the procedure of a peripheral device program searching process that is carried out client terminals (PC(2) and PC(3)).

### DETAILED DESCRIPTION OF THE PREFERRED EMBODIMENTS

The present invention will now be described in detail with reference to the drawings showing a preferred embodiment thereof.

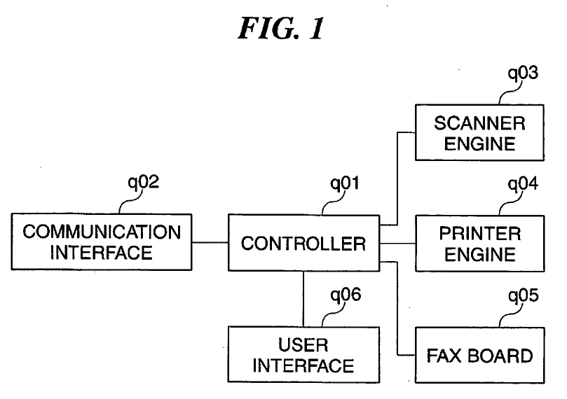

FIG. 1 is a block diagram showing the construction of a peripheral device according to an embodiment of the present invention.

In FIG. 1, a controller q01 controls the peripheral device.

A communication interface q02 provides interface for the controller q01 to communicate with external devices. For example, the communication interface q02 is implemented by the Ethernet (registered trademark) interface or by an IEEE1284 interface. The communication interface q02 may be implemented by other types of communication interface.

A scanner engine q03 is controlled by the controller q01.

A printer engine q04 that is controlled by the controller q01 is implemented, for example, by a laser beam printer or an ink-jet printer. A printer engine q04 may be implemented by other types of printers.

A fax board q05 for carrying out a facsimile communication function, such as communication control during transmitting and receiving of image data, is controlled by the controller q01.

A user interface q06 that is implemented, for example, by an LCD display and a keyboard, displays information transmitted from the controller q01 and transmits instructions from the user to the controller q01.

With the peripheral device having the above construction, it is possible to issue a scan job by the user selecting the scan engine q03. It is also possible to issue a copy job by the user selecting the printer engine q04 and the scanner engine q03. Further, it is possible to issue a facsimile receiving job and a facsimile transmitting job, by the user selecting the printer engine q04, the scanner engine q03, and the fax board q05.

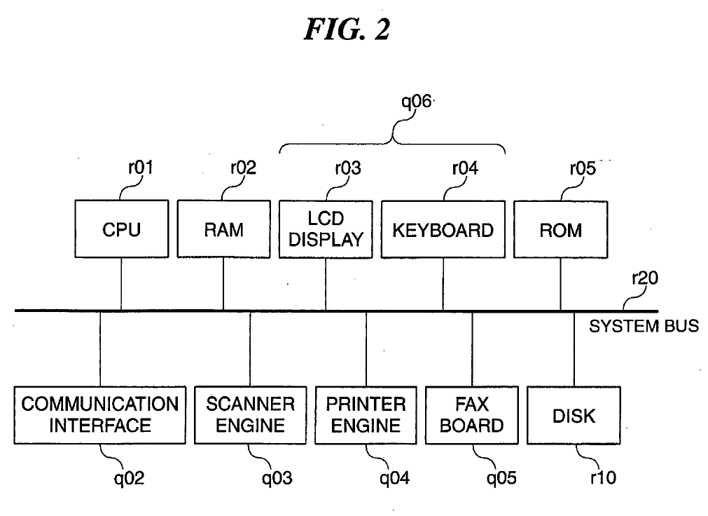

FIG. 2 is a block diagram showing the hardware construction of the peripheral device of FIG. 1.

As shown in FIG. 2, a CPU r01, a RAM r02, a ROM r05, and a DISK r10 construct the controller q01 of FIG. 1. An LCD display r03 and a keyboard r04 construct the user interface q06 of FIG. 1. The components of FIG. 2 are connected together via a system bus r20.

A program that is executed by the controller q01 of FIG. 1 is stored in the ROM r05 or the DISK r10, read out to the RAM r02 as necessary, and executed by the CPU r01. In addition to the control program, the ROM r05 and the DISK r10 store data such as, attribute information on functions and status of the peripheral device and of jobs to be carried out by the peripheral device, and job data to be outputted. The CPU r01 causes the LCD display r03 to display a screen and receives instructions from the user from the keyboard r04. Further, the CPU r01 communicates with external devices via the communication interface q02.

According to the peripheral device of the present embodiment, the CPU r01 receives input instructions from the user from the keyboard r04 via the system bus r20. Based on the instructions received, the CPU r01 controls the RAM r02, the LCD display r03, the ROM r05, the communication interface q02, the scanner engine q03, the printer engine q04, the fax board q05, and the DISK r10.

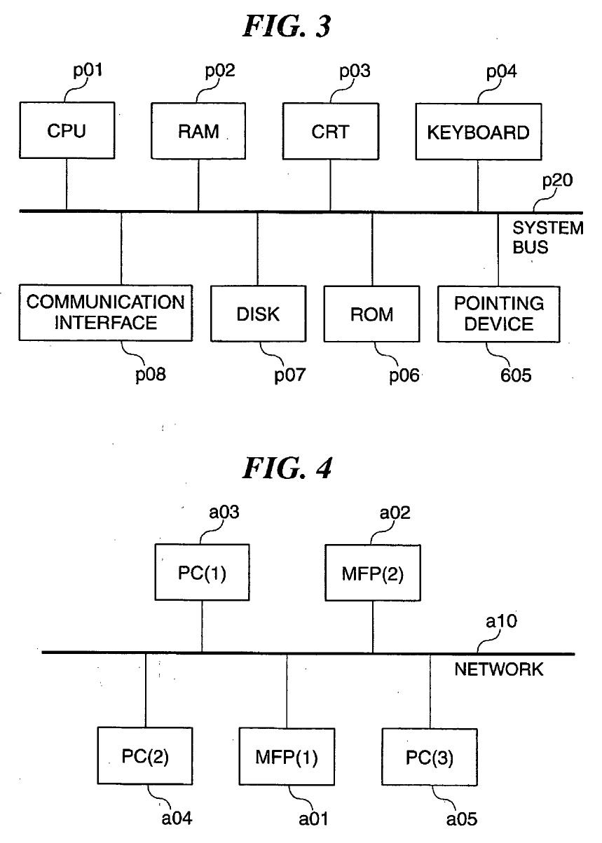

FIG. 3 is a block diagram showing the hardware construction of a personal computer (PC) according to an embodiment of the present invention that configures a network system together with the peripheral device of FIG. 1.

The PC includes a CPU p01, a RAM p02, a CRT p03, a keyboard p04, a pointing device p05, a ROM p06, a DISK p07, and a communication interface p08, which are connected together via a system bus p20. A control program is stored in the ROM p06 or the DISK p07, which is read out to the RAM p02 as necessary and executed by the CPU p01. The CPU p01 causes the CRT p03 to display a screen and receives instructions from the user from the keyboard p04 or the pointing device p05. Further, the CPU p01 communicates with external devices via the communication interface p08.

According to the PC device of the present embodiment, the CPU p01 receives input instructions from the user from the keyboard p04 or the pointing device p05, via the system bus p20. Based on the instructions received, the CPU p01 controls the RAM p02, the CRT p03, the ROM p06, the DISK p07, and the communication interface p08.

FIG. 4 is a block diagram showing the configuration of a network system configured by the peripheral devices of FIG. 1 and the PCs of FIG. 3.

In FIG. 4, each peripheral device (MFP(1) a01 and MFP(2) a02) is comprised of the peripheral device of FIG. 1, and each PC(1) a03, PC(2) a04, and PC(3) a05 is comprised of the PC of FIG. 3, which are connected to each other via a network a10. The PC(1) a03, PC(2) a04, and PC(3) a05 may be work stations, other peripheral devices, or other types of devices.

In the present embodiment, the PC(1) a03 operates as a user authenticating server, while the PC(2) a04 and the PC(3) a05 operate as client servers.

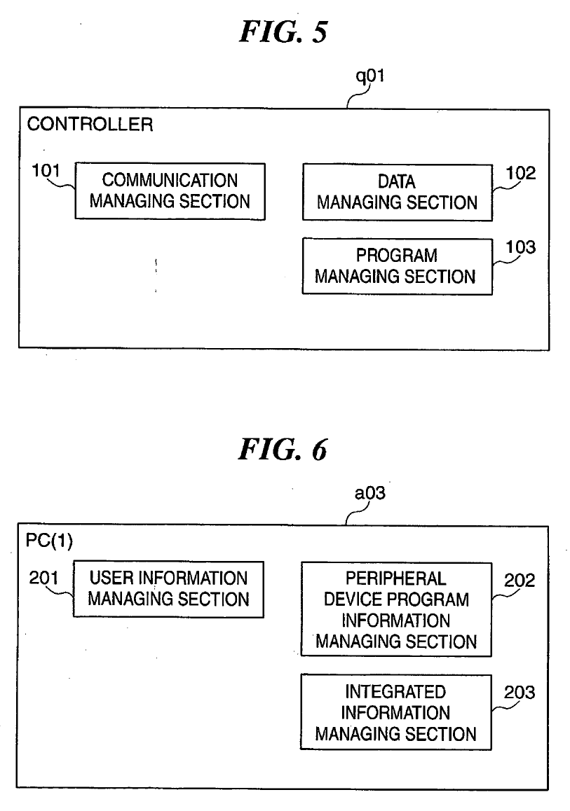

FIG. 5 is a block diagram showing the arrangement of functions of the controller of the peripheral device of FIG. 1.

A communication managing section 101 analyzes communication commands transmitted to and from external devices via the communication interface q02, and carries out communication control.

A data managing section 102 manages various data stored in the RAM r02 or the DISK r10 that are all controlled by the controller q01. Data managed by the data managing section 102 is transmitted to external devices via the communication managing section 101.

A program managing section 103 controls and manages execution of resident programs or non-resident programs out of the data that is managed by the data managing section 102. When handling a program that can be dynamically installed, the installation of the program is managed by the program managing section 103.

FIG. 6 is a block diagram showing the arrangement of functions of the user authenticating server (PC(1) a03).

A user information managing section 201 for managing information on user authentication, manages information to carry out user authentication requested from the client terminals (the PC(2) a04 and the PC(3) a05) that are connected to the network a10 in FIG. 4, via the communication interface p08.

An integrated information managing section 203 for managing information related to peripheral devices, collects information on peripheral devices from the peripheral devices (the MFP(L) a01 and the MFP(2)) that are connected to the network a10, via the communication interface p08.

A peripheral device program information managing section 202 for managing information on programs that are stored in the peripheral devices, stores program information stored in the peripheral devices and information on users who can use the program. The peripheral device program information managing section 202 shows the user information on available programs together with information on the peripheral devices from the integrated information managing section 203.

In the present embodiment, the two functions carried out by the user information managing section 201 and the integrated information managing section 203 are implemented by a single server (the PC(1) a03). However, it may be arranged such that the functions are implemented on different servers. Further, each PC(1) a03, PC(2) a04, and PC(3) a05 are comprised of the same hardware construction as the PC in FIG. 3.

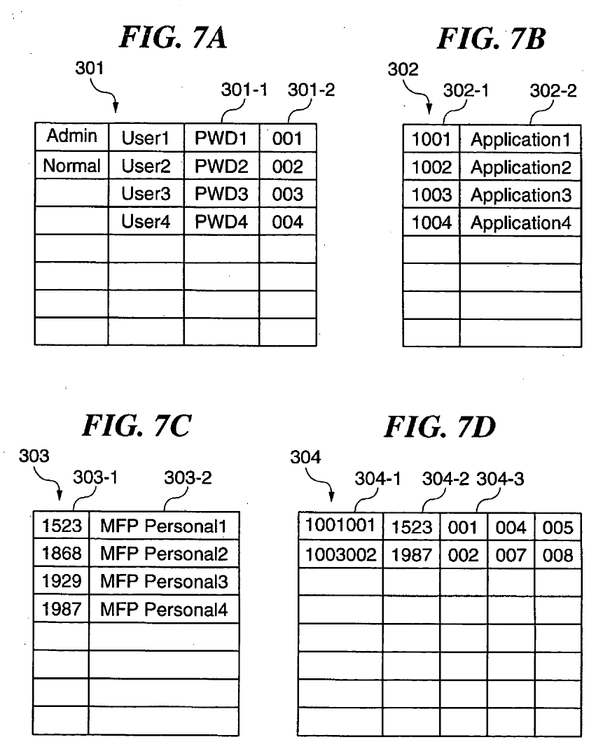

FIGS. 7A to 7D show diagrams of data tables that are stored in the user authenticating server (PC(1) a03).

In FIG. 7A, reference numeral 301 denotes a user information managing table for user authentication. Each record in the user information managing table 301 is managed mainly by the user information managing section 201. A password is listed in a row 301-1, and a user ID is listed in a row 301-2.

In FIG. 7B, reference numeral 302 denotes an application program information managing table. Each record in the application program information managing table 302 is managed mainly by the peripheral device program information managing section 202. An application type ID is listed in a row 302-1, and the name of an application is listed in a row 302-2. The application program includes an application program for converting an image scanned by the scanner engine q03 into a predetermined text file and transmitting the text file to the client terminals on the network. The application program also includes an application program for transmitting an image scanned by the scanner engine q03 to a predetermined server having a storage device. Further, the application program includes an application program for downloading and printing the text file from a folder in the predetermined server.

In FIG. 7C, reference numeral 303 denotes a peripheral device information managing table. Each record in the peripheral device information managing table 303 is managed mainly by the integrated information managing section 203. A peripheral device ID is listed in a row 303-1, and the name of a peripheral device is listed in a row 303-2.

In FIG. 7D, reference numeral 304 denotes a program information managing table. Each record in the program information managing table 304 is managed mainly by the peripheral device program information managing section 202. An application ID, a peripheral device ID, and a user ID are listed in rows 304-1, 304-2, and 304-3, respectively. Application programs that are available to the user and the peripheral devices storing these application programs are shown based on this information.

The four left digits of the application ID listed in the row 304-1 are assigned by referring to the application type ID listed in the row 302-1, and the three right digits indicate the application identifying ID. The peripheral device ID listed in the row 304-2 is assigned by referring to the peripheral device ID listed in the row 303-1. The user ID listed in the row 304-3 is assigned by referring to the user ID listed in the row 301-2.

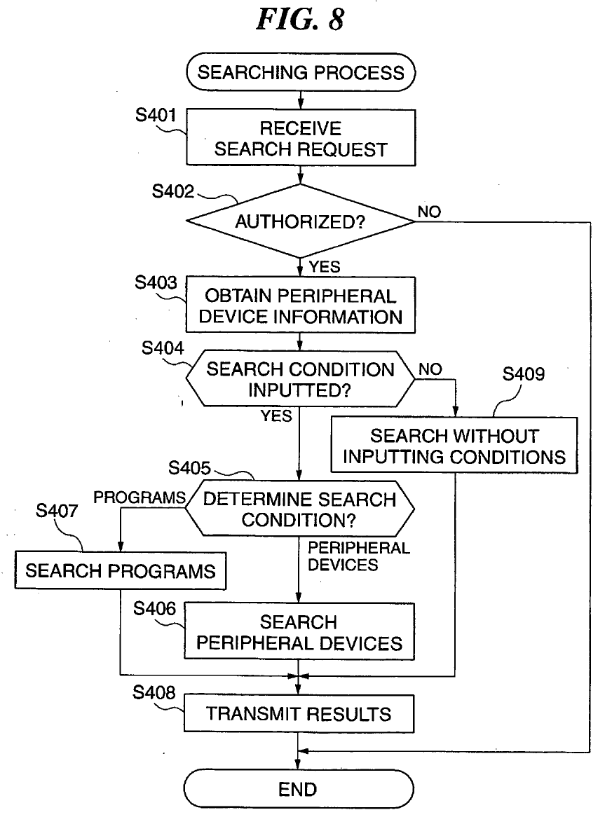

FIG. 8 is a flowchart showing the procedure of a searching process that is carried out by the user authenticating server (PC(1) a03).

In a step S401, the user authenticating server (PC(1) a03) receives a search request from the client terminal (PC(2) a04 or PC(3) a05), via the communication interface p08.

In a step S402, the user authenticating server (PC(1) a03) carries out user authentication of the client terminal (PC(2) a04 or PC(3) a05) which transmitted the search request. If it is determined that the user is an unauthorized user, the searching process is terminated, while if it is determined that the user is an authorized user, the process proceed to a step S403. The user authentication in the step S402 is carried out in the following manner, that is, the user authenticating server (PC(1) a03) receives a user ID and a password from the client terminal (PC(2) a04 or PC(3) a05), and refers to the user information managing table 301 managed by the user information managing section 201 to determine whether or not the user is an authorized user.

In the step S403, the user authenticating server (PC(1) a03) carries out a peripheral device information obtaining process. That is, the user authenticating server (PC(1) a03) transmits an information obtaining request to the peripheral devices (MFP(1) a01 and MFP(2) a02), via the communication interface p08 and obtains peripheral device information, user information, and program information from the peripheral devices. The user authenticating server (PC(1) a03) registers the obtained information with the user information managing table 301, the application program information managing table 302, the program information managing table 304, and the peripheral device information managing table 303.

In a step S404, the user authenticating server (PC(1) a03) determines whether or not a search condition has been inputted from the client terminal (PC(2) a04 or PC(3) a05). If a search condition has been inputted, the process proceeds to a step S405, while if a search condition has not been inputted, the process proceeds to a step S409.

In a step S405, the user authenticating server (PC(1) a03) determines a search condition (object). Specifically, it is determined whether a peripheral device (name) is designated as a search object, or a program (name) is designated as a search object in the search condition. If a peripheral device is designated, the process proceeds to a step S406, and if a program is designated, the process proceeds to a step S407.

In the step S407, the user authenticating server (PC(1) a03) searches the peripheral devices (MFP(1) a01 and MFP(2) a02) having the designated program installed therein, by referring to the information tables 301, 302 and 304, based on the peripheral device information managing table 303 managed by the integrated information managing section 203.

In the step S406, the user authenticating server (PC(1) a03) searches the programs usable by the user, installed in the designated peripheral device, by referring to the information tables 301, 303 and 304, based on the application program information managing table 302.

In the step S408, the user authenticating server (PC(1) a03) transmits the search results obtained by the searches in the step S406 or the step S407, to the client terminal via the communication interface p08.

In the step S409, a search is carried out on peripheral devices (MFP(1) a01 and MFP(2) a02) on the network 10a, on which program searches are carried out, to determine whether or not a program available to the user is installed therein. That is, a search is carried out by referring to the information tables 302, 303 and 304, based on the user information managing table 301 managed by the user information managing section 201. After completion of the search, the process proceeds to the step S408.

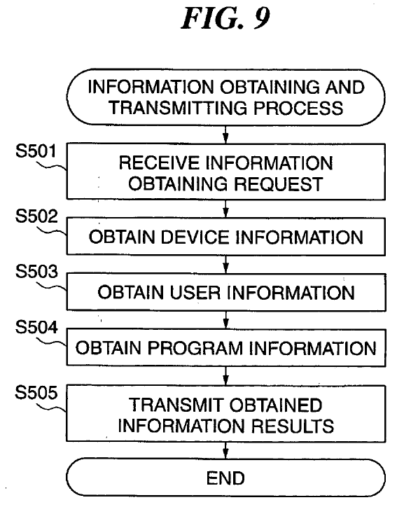

FIG. 9 is a flowchart showing the procedure of an information obtaining and transmitting process that is carried out on the peripheral devices (MFP(1) a01 and MFP(2) a02) according to the peripheral device information obtaining process in the step S403 in FIG. 8.

In a step S501, the peripheral device (MFP(1) a01 or MFP(2) a02) receives a peripheral device information obtaining request from the user authenticating server (PC(1) a03), via the communication interface q02.

In a step S502, the peripheral device (MFP(1) a01 or MFP(2) a02) that received the information obtaining request obtains its peripheral device identification name and peripheral device type ID, as peripheral device identifying information, for identifying itself.

In a step S503, user information is obtained. That is, the user information to be recorded in the user information managing table 301, and the user ID to be recorded in the program information managing table 304, are obtained.

In a step S504, program information is obtained. That is, the application name and the user ID that are to be recorded in the program information managing table 304 and the application information managing table 302, are obtained.

In a step S505, the information obtained by the information obtaining process through the steps S502 to S504 is transmitted by the peripheral device to the user authenticating server (PC(1) a03), via the communication interface q02.

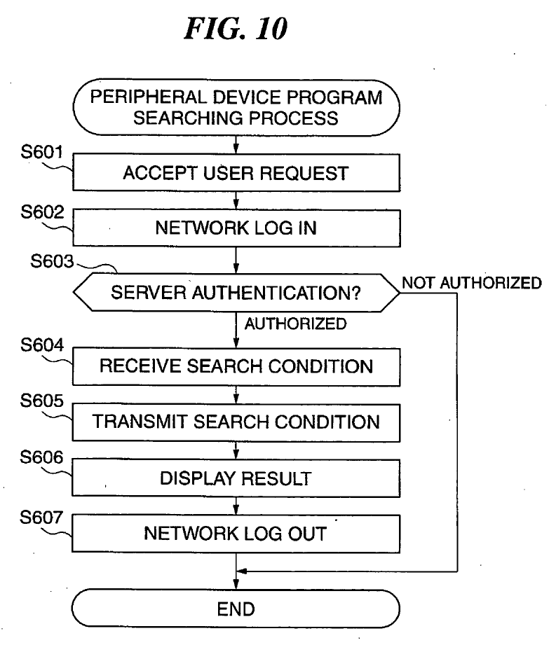

FIG. 10 is a flowchart showing the procedure of a peripheral device program searching process that is carried out on the client terminals (PC(2) a04 and PC(3) a05).

In a step S601, the client terminal (PC(2) a04 or PC(3) a05) accepts a peripheral device program search inputted by the user via the keyboard p04 or the pointing device p105 of the client terminal.

In a step S602, the client terminal carries out a network log in process, via the communication interface p08 and the network a10.

In a step S603, the client terminal requests the user authenticating server (PC(1) a03) to carry out authentication. That is, by inputting a user ID and a password into the user authenticating server, the client terminal prompts the user authenticating server to execute the authentication process in the step S402 of FIG. 8. As a result, if the user is authorized, the process proceeds to a step S604, and if the user is not authorized, the peripheral device program search process is terminated.

In the step S604, the client terminal (PC(2) a04 or PC(3) a05) receives a searching condition inputted by the user. Even if no searching condition has been entered by the user, if it is confirmed that the searching condition input process has terminated, the process proceeds to a step S605.

In the step S605, the client terminal (PC(2) a04 or PC(3) a05) transmits the received searching condition to the user authenticating server (PC(1) a03), via the communication interface p08. The user authenticating server (PC(1) a03) carries out the process described in the step S404 of FIG. 8 based on the received searching condition.

In a step S606, upon receipt of a search result transmitting request transmitted from the client terminal, the user authenticating server (PC(1) a03) carries out the process described in the step S408 of FIG. 8. As a result, the client terminal receives the search result from the user authenticating server (PC(1) a03) and displays the results on the CRT p03, to thereby show the user the programs in the peripheral devices that are available to the user.

In a step S607, the client terminal (PC(2) a04 or PC(3) a05) carries out a network log out process and terminates the peripheral device program searching process.

As described above, according to the present invention, it is possible to reduce the burden placed upon the user searching programs on a plurality of peripheral devices to obtain necessary information. That is, it is possible to reduce the troublesome task on the user having to carry out authentication on each peripheral device to search programs. Also, it becomes possible to carry out a search that can quickly cope with dynamic program changes.

Further, it is possible to reduce the burden placed upon the user having to access each peripheral device to search the programs available on the peripheral devices.

It is to be understood that the object of the present invention may be accomplished by supplying a system or an apparatus with a storage medium in which a program code of software which realizes the functions of the above described embodiment is stored, and causing a computer (or a CPU or an MPU) of the system or the apparatus to read out and execute the program code stored in the storage medium.

In this case, the program code itself read from the storage medium realizes the functions of the above described embodiment, and hence the program code and the storage medium in which the program code is stored constitute the present invention.

Examples of the storage medium for supplying the program code include a floppy (registered trademark) disk, a hard disk, a magnetic-optical disk, an optical disk such as a CD-ROM, a CD-R, a CD-RW, a DVD-ROM, a DVD-RAM, a DVD-RW, and a DVD+RW, a magnetic tape, a nonvolatile memory card, and a ROM. Alternatively, the program code may be supplied by downloading from a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

### CROSS REFERENCE TO RELATED APPLICATION

This application claims priority from Japanese Patent Application No. 2004-337762 filed Nov. 22, 2004, which is hereby incorporated by reference herein.

What is claimed is:

1. An information managing apparatus connected to a plurality of peripheral devices via a network comprising:
a user authentication executing device that carries out a user authentication in response to a request from a client terminal, to obtain information related to programs that are installed in each of the plurality of peripheral devices;
an obtaining device that obtains information on each of the plurality of peripheral devices and programs that are stored in each of the plurality of peripheral devices via the network, when authorization is given by said user authentication executing device;
a determining device that determines whether search condition designated by the client terminal is a peripheral device or a program; and
a notifying device that notifies the client terminal of program information in a case where the search condition is a peripheral device, and notifies the client terminal of peripheral device information in a case where the search condition is a program.

2. An information managing apparatus as claimed in claim 1, wherein said obtaining device determines whether or not a user of the client terminal requesting the information is authorized to use the programs, and said notifying device notifies the client terminal the programs available to the user.

3. A search program that is applied to an information managing apparatus connected to a plurality of peripheral devices via a network comprising:
a user authentication executing step of carrying out user authentication in response to a request from a client terminal, to obtain information related to programs that are installed in each of the plurality of peripheral devices, based on user authenticating information stored in a user authenticating information storing device;
an obtaining step of obtaining information on each of the plurality of peripheral devices and programs that are stored in each of the plurality of peripheral devices via the network, when authorization is given in said user authentication executing step;
a determining step of determining whether search condition designated by the client terminal is a peripheral device or a program; and
a notifying step of notifying the client terminal of program information in a case where the search condition is a peripheral device, and notifying the client terminal of peripheral device information in a case where the search condition is a program.

4. A search program as claimed in claim 3, wherein said obtaining step determines whether or not a user of the client terminal requesting the information is authorized to use the programs, and said notifying step notifies the client terminal the programs available to the user.

5. A program for causing a computer to execute a search program that is applied to an information managing apparatus connected to a plurality of peripheral devices via a network comprising:
a user authentication executing step of carrying out user authentication in response to a request from a client terminal to obtain information related to programs that are installed in each of the plurality of peripheral devices, based on user authenticating information stored in a user authenticating information storing device;
an obtaining step of obtaining information on each of the plurality of peripheral devices and programs that are stored in each of the plurality of peripheral devices via the network, when authorization is given in said user authentication executing step;
a determining step of determining whether search condition designated by the client terminal is a peripheral device or a program; and
a notifying step of notifying the client terminal of program information in a case where the search condition is a peripheral device, and notifying the client terminal of peripheral device information in a case where the search condition is a program.
